(19) United States
(12) Patent Application Publication
(10) Pub. No.: US 2022/0349626 A1
(43) Pub. Date: Nov. 3, 2022

(54) AIR-COOLED PROGRESSIVELY TWO-STAGE REFRIGERATION SYSTEM

(71) Applicant: Zhao Ri Gan, Long Beach, CA (US)

(72) Inventor: Zhao Ri Gan, Long Beach, CA (US)

(21) Appl. No.: 17/246,517

(22) Filed: Apr. 30, 2021

(51) Int. Cl. F25B 5/02; F25B 49/02

(52) U.S. Cl. CPC F25B 5/02; F25B 49/02; F25B 2600/112; F25B 2700/2117

(57) ABSTRACT

An air-cooled progressively two-stage refrigeration system comprising: a compressor; a condenser; and an evaporator, which is connected to the condenser and the compressor respectively, and the evaporator contains a high-temperature portion, a fan, and a middle-temperature portion, the high-temperature portion and the middle-temperature portion are respectively located on two sides of the evaporator, and the fan is set between the high-temperature portion and the middle-temperature portion, and air enters the evaporator from one side of the high-temperature portion, passes through the fan and then is sent out from one side of the middle-temperature portion, and a first evaporation coil is provided in the high-temperature portion, and a second evaporation coil is provided in the middle-temperature portion; wherein the fan accelerates the cooled air in the high-temperature portion to the middle-temperature portion to undergo another cooling process, so as to reduce the energy consumption of the system.

### FIELD OF THE INVENTION

The present invention relates generally to a refrigeration system. Moreover, the present invention relates to an air-cooled progressively two-stage refrigeration system. It is a refrigeration system that using a two-stage refrigerating method to lower the energy consumption that is, splitting evaporation coil into two to form two temperature zones, and the first one will deal with the heat includes sunlight, outdoor heat, and half of latent heat of the pipeline, while the other one will only deal with the heat includes the indoor heat and the half of latent heat of the pipeline, and this method will lower the energy consumption compared to the normal air-cooled single-coil refrigeration system.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

As we all know, the refrigeration system (like air conditioner) sold on the market has been widely loved by the public and has become an indispensable home appliance product in life. It is even installed in almost every household, shop, office building, etc. in all countries and regions around the world. Although the product is widely loved, it has become one of the most energy-consuming products. Furthermore, in recent years, the average temperature rise due to warming has caused the demand for air-conditioning equipment to increase, so how to be effective reducing the proportion of energy consumption of the refrigeration system has become one of the issues that technical researchers in this field want to solve.

Currently in the market, all refrigeration systems adopt a one-stage cooling mode. In the cooling process, the condenser needs to resist the high temperature of the outside world, such as sunlight, outdoor heat wave, indoor hot air, and latent heat inside the machine, which consumes tremendous amount of electric energy. To solve this problem, the manufacturers in this industry is trying various of ways to develop condensers with high-efficiency heat dissipation effects. Like, increase the heat dissipation area, use double-layer coils to enhance the heat dissipation effect, increase SEER (Seasonal Energy Efficiency Ratio) from 8 to 26, use high-pressure refrigerant, or increase exhaust fan power to strive to discharge more heat to achieve a lower temperature refrigerant liquid. However, these methods do not have a significant effect on reducing energy consumption.

In view of this, the inventor feels that the prior art is not perfect, and based on his accumulated experience in this industry for over 40 years, he provides an air-cooled progressively two-stage refrigeration system to improve the high energy consumption problem of the above-mentioned conventional technology.

### SUMMARY

One objective of the present invention is to provide an air-cooled progressively two-stage refrigeration system, which reduces energy consumption by changing the one-time refrigeration system to this two-stage refrigeration system.

The system comprising:
a compressor;
a condenser; and
an evaporator, which is connected to the condenser and the compressor respectively, and the evaporator contains a high-temperature portion, a fan, and a middle-temperature portion, the high-temperature portion and the middle-temperature portion are respectively located on two sides of the evaporator, and the fan is set between the high-temperature portion and the middle-temperature portion, and air enters the evaporator from one side of the high-temperature portion, passes through the fan and then is sent out from one side of the middle-temperature portion, and a first evaporation coil is provided in the high-temperature portion, and a second evaporation coil is provided in the middle-temperature portion;
wherein, refrigerant from the condenser in the system enters the first evaporation coil and the second evaporation coil through an expansion valve respectively, so that the first evaporation coil and the second evaporation coil respectively cool the air in the high-temperature portion and the middle-temperature portion, and the fan accelerates the cooled air in the high-temperature portion to the middle-temperature portion to undergo another cooling process, so as to reduce the energy consumption of the system.

In one non-limiting embodiment, the condenser and the evaporator are connected to each other through a receiver.

In another aspect, there will be a time difference between the refrigerant entering the first evaporation coil and the second evaporation coil respectively. In some situation, the refrigerant will be first entering the first evaporation coil and then entering the second evaporation coil.

In another aspect, the compressor and the evaporator are connected to each other through an accumulator.

In another aspect, a temperature detector is located in the middle-temperature portion, and the temperature detector is near the side of the middle-temperature portion where the air is sent out.

In another aspect, the system further comprising a fan controller, which is connected with the fan and the temperature detector, when the temperature detector detects that the temperature in the middle-temperature portion is the same as or lower than a designed temperature, the fan controller will reduce the rotation speed of the fan, but will not stop the fan from rotating.

In another aspect, the designed temperature can be changed by user.

In another aspect, the system further comprising a thermostat located on the evaporator, and the thermostat is connected with the temperature detector to let user change the designed temperature.

Another objective is to enhance the system's temperature resistance.

Yet another objective is to allow the system to function well during extremely high temperature which is increasingly common due to global warming.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a schematic view of an air-cooled progressively two-stage refrigeration system in accordance with an embodiment of the present invention;

FIG. 2 illustrates a schematic view of a flow of refrigerant in the air-cooled progressively two-stage refrigeration system shown in FIG. 1;

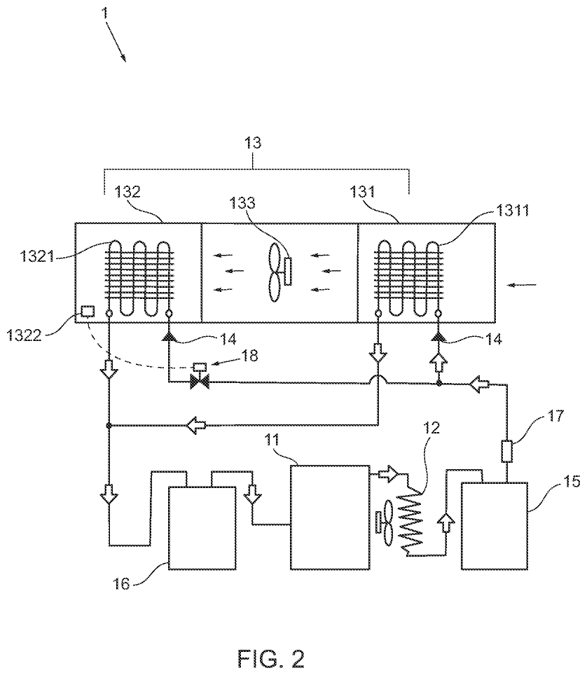

FIG. 3 illustrates a schematic diagram showing the connection of the electronic components in the air-cooled progressively two-stage refrigeration system in accordance with an embodiment of the present invention;

FIGS. 4A & 4B illustrate schematic diagrams showing the energy efficiency difference between the tradition one-stage (single coil) refrigeration system and the air-cooled progressively two-stage refrigeration system.

Like reference numerals refer to like parts throughout the various views of the drawings.

### DETAILED DESCRIPTION OF THE INVENTION

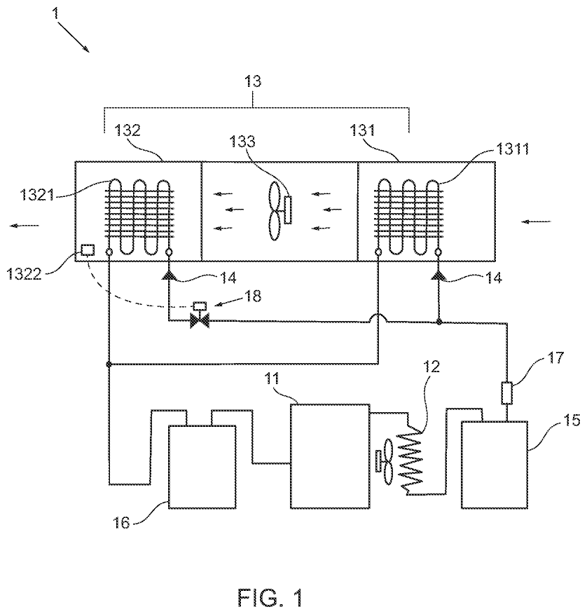

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Please refer to FIGS. 1 & 2, they shows a schematic view of an air-cooled progressively two-stage refrigeration system and how does a flow of refrigerant move in the air-cooled progressively two-stage refrigeration system. The air-cooled progressively two-stage refrigeration system 1 comprising:
a compressor 11;
a condenser 12; and
an evaporator 13, which is connected to the condenser 12 and the compressor 11 respectively, and the evaporator 13 contains a high-temperature portion 131, a fan, and a middle-temperature portion, the high-temperature portion 131 and the middle-temperature portion 132 are respectively located on two sides of the evaporator 13, and the fan 133 is set between the high-temperature portion 131 and the middle-temperature portion 132, and air enters the evaporator 13 from one side of the high-temperature portion 131, passes through the fan 133 and then is sent out from one side of the middle-temperature portion 132, and a first evaporation coil 1311 is provided in the high-temperature portion 131, and a second evaporation coil 1321 is provided in the middle-temperature portion 132;
wherein, refrigerant from the condenser 12 in the system 1 enters the first evaporation coil 1311 and the second evaporation coil 1321 through an expansion valve 14 respectively, so that the first evaporation coil 1311 and the second evaporation coil 1321 respectively cool the air in the high-temperature portion 131 and the middle-temperature portion 132, and the fan 133 accelerates the cooled air in the high-temperature portion 131 to the middle-temperature portion 132 to undergo another cooling process, so as to reduce the energy consumption of the system 1;
wherein, the condenser 12 and the evaporator 13 are connected to each other through a receiver 15, and the compressor 11 and the evaporator 13 are connected to each other through an accumulator 16.

It can be clearly seen from the FIGS. 1 & 2 that the present invention divides the coils in the evaporator 13 into the first evaporation coil 1311 and the second evaporation coil 1321, and the two coils have different functions in the evaporator 13. The first evaporation coil 1311 is installed in the high-temperature portion 131 to simultaneously deal with outdoor heat, part of the indoor heat and part of the pipeline latent heat, while the second evaporation coil 1321 is installed in the middle-temperature portion 132, because the first evaporation coil 1311 has already dealt with the outdoor heat, the function of the second evaporation coil 1321 is to continue processing the remaining indoor heat and pipeline latent heat. In addition, the present invention provides a sight glass moisture indicator 17 for users to know the moisture in the pipeline, and the present invention also provides a solenoid valve for users to control the flow or pressure of the refrigerant in the pipeline. Furthermore, the accumulator 16 is a suction accumulator, which can do a lower pressure of 50 psi (for R-438A related system) or a high pressure of 200 psi (for R22 related system).

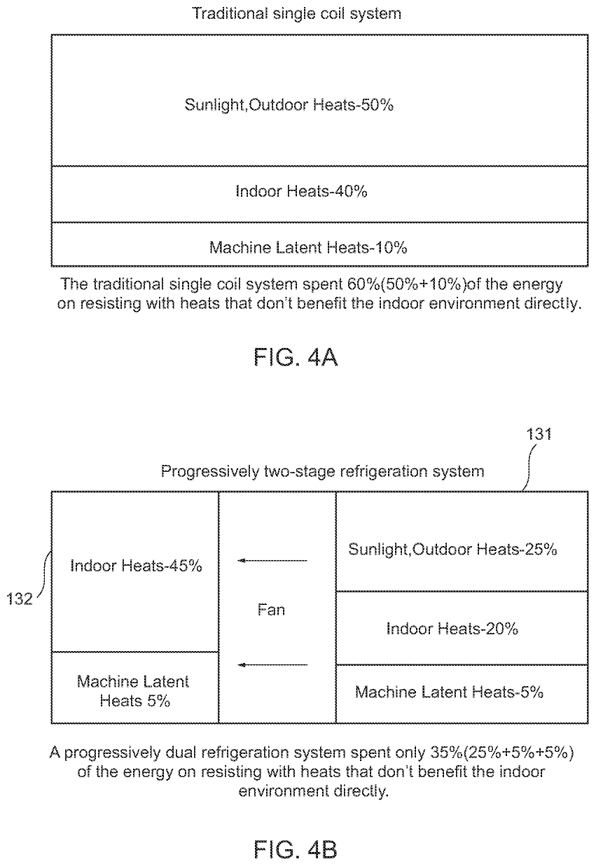

In detail, take FIG. 4A as an example, which is an analysis diagram of energy consumption of a traditional one-stage refrigeration system 1. When the total heat is 100%, the sunlight and outdoor heat are about 50%, the indoor heat is 40%, and the pipeline latent heat is 10%. That is to say, the energy spent on resisting with heats that don't benefit the indoor environment in this system 1 is 60%. But please continue to look at FIG. 4B, when the refrigeration system is changed to use the two-stage refrigeration system 1 as described in the present invention, the energy used by the first evaporation coil 1311 and the second evaporation coil 1321 are respectively 50% of the coil of the one-stage refrigeration system. The first evaporation coil 1311 distributes 25% of the sunlight, outdoor heat and 5% of the latent heat of the pipeline, while the second evaporation coil 1321 distributes 45% of the indoor heat and 5% of the latent heat of the pipeline. The first evaporation coil 1311 and the second evaporation coil 1321 actually consume 65% of the energy in cooling the indoor air, and the energy spent on resisting with heats that don't benefit the indoor environment in this two-stage refrigeration system 1 is 35%. The conclusion is that compared with the one-stage refrigeration system, the actual capacity of the two-stage refrigeration system 1 is increased by 25%, and the energy wasted on outdoor heats is reduced from 60% to 35%, so it can be clearly shown that the present invention can indeed improve the cooling performance and energy conservation.

In some embodiments, there will be a time difference between the refrigerant entering the first evaporation coil 1311 and the second evaporation coil 1321 respectively, and this will make the high-temperature portion 131 and the middle-temperature portion 132 more efficient in cooling the air.

On the other hand, from the performance of air convection, when the hot air from outside enters the high-temperature portion 131, the first evaporation coil 1311 will first cool the hot air (first stage cooling), and then quickly transfer the air to the middle-temperature portion 132 through the fan 133. In the middle-temperature portion 132, the second evaporation coil 1321 will then perform the second stage of cooling on the air that has been initially cooled in the high-temperature portion 131. In this way, under the same energy consumption, compared with the prior art (one-stage refrigeration system), the temperature of the cold air finally discharged from the middle-temperature portion 132 is lower, and this result is known through experiments conducted by the inventor. In the experiment, the one-stage refrigeration system and the present invention have the same energy consumption, and the discharged cold air is 60° F. and 45° F. respectively, which can prove that the refrigeration effect of the present invention is stronger under the same energy consumption. Therefore, those skilled in the art can clearly understand that the energy consumption of the present invention is lower than that of the prior art when they both discharge cold air with the same temperature.

Furthermore, the fan 133 is arranged between the high-temperature portion 131 and the middle-temperature portion 132 in order to separate the two portions by a certain distance, so that the air in the middle-temperature portion 132 and the high-temperature portion 131 will not interfere with each other, so as to avoid affecting the respective cooling processes of the middle-temperature portion 132 and the high-temperature portion 131. And, the fan 133 arranged in the middle section of the evaporator 13 can also achieve a rectification effect of the air flow in the evaporator 13, thereby avoiding the unsmooth air flow in the evaporator 13. That is, because of the high density of the evaporation coils, there is a certain obstruction in the evaporator 13, so when the fan 133 is set in the middle, there is only one evaporation coil at the position of positive wind pressure, and there is only one evaporation coil at the position of negative wind pressure, and the overall wind direction receives the least resistance. However, if the fan 133 is placed at either end, the obstruction will become larger and the air flow rate will not be reached. After the measurement, it is found that when the fan 133 is placed in the middle, the airflow reaches 2000 CFM, but when the fan 133 is placed at either end, the airflow is only about 1600 CFM. It can be seen that it is necessary to place the fan 133 in the middle.

The following Table 1 is the experimental data obtained by the inventor after the energy consumption detection experiment for the one-stage refrigeration system (R22 system) and the present invention.

TABLE 1

| | high pressure (psi) | Current (A) | energy saved (W) |
|---|---|---|---|
| R22 system | 250 | 25 | — |
| Two-stage | 190-200 | 20 | 1000 |
| refrigeration system | | | |

It can be clearly seen from Table 1 that the normal high pressure for a one-time refrigeration system (R22 system) is 250 psi, with a current measure of 25 A, and the high pressure for two-stage refrigeration system 1 is 190-200 psi with a current measure of 20 A. The energy saving is estimated many times at an average of 1000 W.

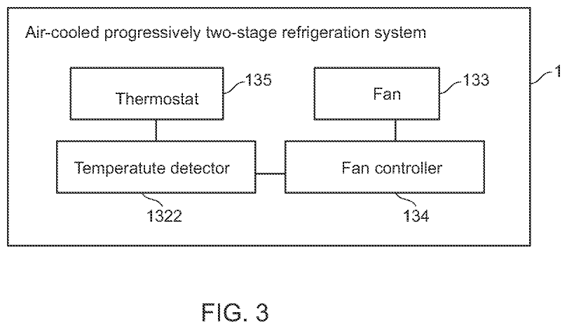

Looking now at FIG. 3, in other embodiments, the present invention also includes a temperature detector 1322, a fan controller 134, and a thermostat 135. The temperature detector 1322 is located in the middle-temperature portion 132, and the temperature detector 1322 is near the side of the middle-temperature portion 132 where the air is sent out. The fan controller 134 is connected with the fan 133 and the temperature detector 1322. The thermostat 135 located on the evaporator 13, and the thermostat 135 is connected with the temperature detector 1322.

In use, when the temperature detector 1322 detects that the temperature in the middle-temperature portion 132 is the same as or lower than a designed temperature (better if located between 40° F.˜45° F.), the fan controller 134 will reduce the rotation speed of the fan 133, but will not stop the fan 133 from rotating. This can further save some energy, but it will not affect the smoothness of airflow. Moreover, the setting of the thermostat 135 allows the user to adjust the designed temperature by himself, so as to make the use of the present invention more convenient, and the designed temperature can also be adjusted in other ways and is not limited to this embodiment.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An air-cooled progressively two-stage refrigeration system, the system comprising:
a compressor;
a condenser; and
an evaporator, which is connected to the condenser and the compressor respectively, and the evaporator contains a high-temperature portion, a fan, and a middle-temperature portion, the high-temperature portion and the middle-temperature portion are respectively located on two sides of the evaporator, and the fan is set between the high-temperature portion and the middle-temperature portion, and air enters the evaporator from one side of the high-temperature portion, passes through the fan and then is sent out from one side of the middle-temperature portion, and a first evaporation coil is provided in the high-temperature portion, and a second evaporation coil is provided in the middle-temperature portion;
wherein, refrigerant from the condenser in the system enters the first evaporation coil and the second evaporation coil through an expansion valve respectively, so that the first evaporation coil and the second evaporation coil respectively cool the air in the high-temperature portion and the middle-temperature portion, and the fan accelerates the cooled air in the high-temperature portion to the middle-temperature portion to undergo another cooling process, so as to reduce the energy consumption of the system.

2. The system of claim 1, wherein the condenser and the evaporator are connected to each other through a receiver.

3. The system of claim 1, wherein there will be a time difference between the refrigerant entering the first evaporation coil and the second evaporation coil respectively.

4. The system of claim 1, wherein the compressor and the evaporator are connected to each other through an accumulator.

5. The system of claim 1, wherein a temperature detector is located in the middle-temperature portion, and the temperature detector is near the side of the middle-temperature portion where the air is sent out.

6. The system of claim 4, the system further comprising a fan controller, which is connected with the fan and the temperature detector, when the temperature detector detects that the temperature in the middle-temperature portion is the same as or lower than a designed temperature, the fan controller will reduce the rotation speed of the fan, but will not stop the fan from rotating.

7. The system of claim 5, wherein the designed temperature can be changed by user.

8. The system of claim 5, the system further comprising a thermostat located on the evaporator, and the thermostat is connected with the temperature detector to let user change the designed temperature.
